(19) United States
(12) Patent Application Publication
(10) Pub. No.: US 2026/0371030 A1
(43) Pub. Date: Nov. 19, 2026

(54) Global Audio Positioning System

(71) Applicant: Apple Inc., Cupertino, CA (US)

(72) Inventor: Jared King, Hermosa Beach, CA (US)

(21) Appl. No.: 19/545,347

(22) Filed: Feb. 20, 2026

Related U.S. Application Data
(60) Provisional application No. 63/806,408, filed on May 15, 2025.

(51) Int. Cl. H04S 7/00; G06T 7/70; H04R 3/00; H04R 5/027

(52) U.S. Cl. CPC H04S 7/304; G06T 7/70; H04R 3/005; H04R 5/027; G06T 2207/10016; H04S 2400/11; H04S 2400/15; H04S 2420/11

(57) ABSTRACT

Global audio positioning systems and methods are described. In an aspect, a plurality of capture nodes and a plurality of microphones capture video data and audio data, respectively, from a physical space. Capture node locations and audio object scene locations may be extracted from the video data and audio data, respectively, and mapped to a virtual space, where the capture node locations and the audio object scene locations are measured from a virtual origin point. Based on a selected capture node, audio object presentation locations may be determined for each audio object, where the audio object presentation locations are measured from the capture node location of the selected capture node. Further, based on the audio objects and the audio object presentation locations, spatial audio may be generated, where the spatial audio and the video data from the selected capture node may be synchronized and transmitted to an immersive device.

### RELATED APPLICATIONS

This application claims the benefit of priority of U.S. Provisional Application No. 63/806,408, filed May 15, 2025, which is herein incorporated by reference.

### BACKGROUND

### FIELD

Aspects described herein relate to immersive media production, more specifically to the respatialization of audio objects.

### BACKGROUND INFORMATION

The demand for immersive media productions has seen significant growth in recent years, reflecting consumers' increasing preference for interactive and spatial experiences over traditional passive content. In response to the demand, entertainment industries have integrated more immersive elements into their productions, with many studios now incorporating 360° video, spatial audio and interactive components into mainstream content. In addition, other sectors such as education, healthcare, industrial applications, etc., are embracing immersive media for training, visualization and remote collaboration capabilities among other benefits.

### SUMMARY

Global audio positioning systems and methods are described. In an aspect, a global audio positioning system (“system”) receives video data captured by a plurality of capture nodes (e.g., digital video camera) in a physical space, and receives audio data captured by a plurality of microphones in the same physical space. The system may extract capture node locations from the video data, and extract audio objects (and audio object scene locations) from the audio data, where such locations may be measured from a physical origin point in the physical space. Further, the system may map the capture nodes to a virtual space based on their respective capture node locations, and may map the audio objects to the same virtual space based on their respective audio object scene locations, where such locations may be measured from a virtual origin point in the virtual space. In such instances, the virtual space and the physical space use a common coordinate system to maintain accurate spatial relationships between these spaces. Upon the selection of a selected capture node for presentation to the user, the system may determine audio object presentation locations for each audio object, where the audio object presentation locations may be measured from the capture node location of the selected capture node (rather than from the virtual origin point). Based on the audio objects and audio object presentation locations determined for each audio object, the system may generate spatial audio, where the spatial audio and the video data from the selected capture node may be synchronized and transmitted to an immersive device (e.g., head-word device, etc.).

### BRIEF DESCRIPTION OF THE DRAWINGS

FIG. 1A is a schematic illustration of a global audio positioning system in accordance with aspects.

FIG. 1B is a schematic illustration of a processing device connected to a plurality of capture nodes and a plurality of microphones in a physical space in accordance with aspects.

FIG. 2 is a flow chart of a method for the respatialization of audio objects in accordance with aspects.

FIG. 3A is a schematic perspective view illustration of a virtual space from the perspective of a selected capture node in accordance with aspects.

FIGS. 3B-3E are schematic top view illustrations of a method for the respatialization of audio objects in the virtual space illustrated in FIG. 3A in accordance with aspects.

### DETAILED DESCRIPTION

Similar to traditional media productions, immersive media productions (e.g., virtual reality (VR), augmented reality (AR), mixed reality (MR), extended reality (XR), etc.) use multiple cameras to enhance the feeling of reality and presence at each visual location provided by each camera. In one example, during MR live events, it has been observed that each MR camera must have its own dedicated MR audio mixer to create local audio presentations for each respective MR camera. Further, many audio objects (e.g., point sources, surround sources, higher audio sources, non-diegetic sources, etc.) are shared between the many local audio presentations created for each respective MR camera, where each audio object must be individually copied and placed in space using x-y-z coordinates to define their proper locations with respect to the visual perspective presented to the user. This process is complex and inefficient as it is a manual and iterative procedure from camera to camera. Further, if an MR camera is moved to a new position during the broadcast, the MR audio mixer must start from scratch and entirely rebuild the location audio presentations on the fly, which often causes audible and visual disruptions to the broadcast. Lastly, when transmitting audio and video data to the user, a large separate multichannel audio mix for each camera must be transmitted along with the corresponding video data, where much of the content that makes up the large separate multichannel audio mix is redundant. It has been observed that sending such large and redundant multichannel audio streams results in an increased need in processing power for encoding, compressing and transmitting the audio data, as well as increased bandwidth and cost to transmit the redundant data from capture to client.

In accordance with aspects, global audio positioning systems and methods are described for the real-time and automatic respatialization of any number of audio objects into any number of separate and simultaneous spatial audio presentations whose auditory perspectives accurately adhere to the visual perspective of the camera (e.g., capture node) selected for presentation to the user. In one aspect, system 100 receives video data from a plurality of capture nodes and audio data from a plurality of microphones, where the plurality of capture nodes and the plurality of microphones are located in a physical space. Further, system 100 extracts capture node locations for each of the plurality of capture nodes and extracts audio object scene locations for each audio object captured by the plurality of microphones, where the plurality of capture nodes are mapped to a virtual space based on their respective capture node locations and the audio objects are mapped to the virtual space based on their respective audio object scene locations. In such instances, the capture node locations and the audio object scene locations are measured from a virtual origin point in the virtual space. After mapping to the virtual space (e.g., scene definition), system 100 may determine audio object presentation locations for each of the audio objects in the virtual space based on a capture node selected for presentation to the user, where the audio object presentation locations are measured from the capture node location of the selected capture node (rather than from the virtual origin point). Based on the audio objects and the audio object presentation locations measured from the capture node location of the selected capture node, system 100 may generate spatial audio. In such instances, the spatial audio and the video data captured by the selected capture node may be synchronized and transmitted to an immersive device (e.g., head-worn device). Further, system 100 may be included in a singular processing device (e.g., audio mixer, etc.) connected to the plurality of microphones and the plurality of capture nodes so that the singular processing device can perform all the operations of system 100, as opposed to conventional methods in which each capture node in the plurality of capture nodes would require its own respective audio mixer. In this way, the automatic respatialization of audio objects to correspond to any given capture node in real-time offers a drastic reduction in the set-up time for immersive productions, increases auditory accuracy and realism at each capture node, and reduces the audio routing complexity, network bandwidth and processing resources required during live transmission.

In various aspects, description is made with reference to figures. However, certain aspects may be practiced without one or more of these specific details, or in combination with other known methods and configurations. In the following description, numerous specific details are set forth, such as specific configurations, dimensions and processes, etc., in order to provide a thorough understanding of the aspects. In other instances, well-known digital audio signal processing techniques processes have not been described in particular detail in order to not unnecessarily obscure the aspects. Reference throughout this specification to “one aspect” means that a particular feature, structure, configuration, or characteristic described in connection with the aspect is included in at least one aspect. Thus, the appearances of the phrase “in one aspect” in various places throughout this specification are not necessarily referring to the same aspect. Furthermore, the particular features, structures, configurations, or characteristics may be combined in any suitable manner in one or more aspects.

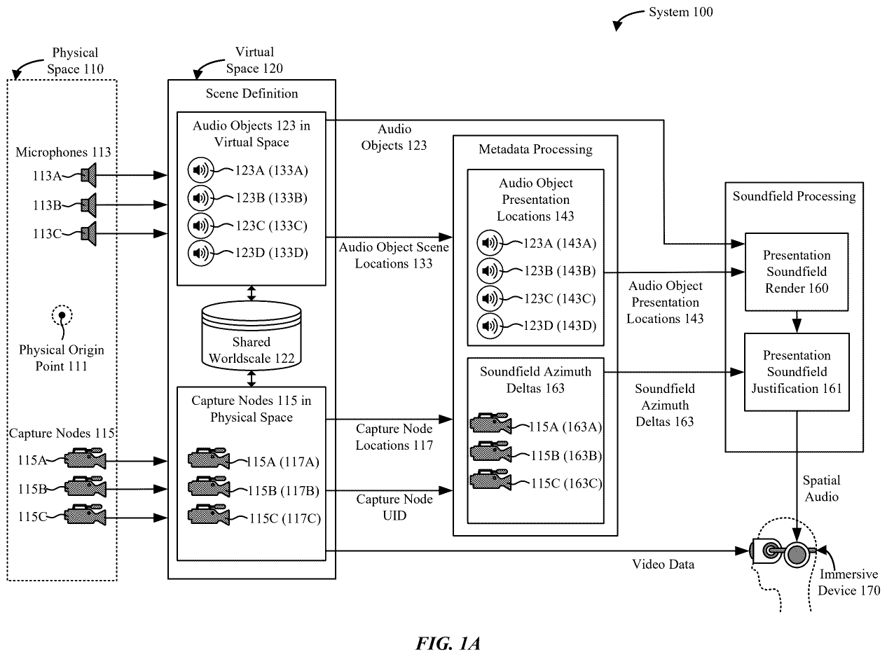

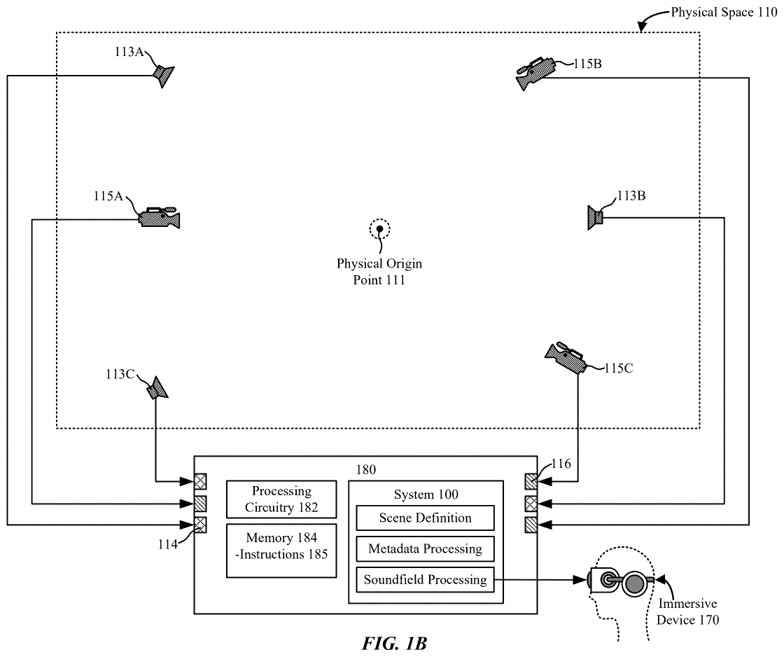

Referring now to FIG. 1A, a schematic illustration of a global audio positioning system (“system”) 100 is shown in accordance with aspects. In one aspect, system 100 receives video data captured by a plurality of capture nodes and receives audio data captured by a plurality of microphones, where the plurality of capture nodes and the plurality of microphones are located in a physical space, such as physical space 110 illustrated in FIG. 1A. The physical space may be an actual environment where the video data and audio data may be captured. The audio data may include any physical object, person, event, etc. that generates acoustic energy that can be captured by the plurality of microphones in the physical space (e.g., sound source, etc.). The video data may include any physical object, person, scene, event, etc., that generates or reflects light that can be captured by plurality of capture nodes in the physical space (e.g., visual source, etc.). Example physical spaces may include but are not limited to live event spaces (e.g., sports arenas, concert venues, theaters, etc.), production spaces (e.g., natural/outdoor environments, landscapes, urban settings, etc.), controlled studio environments designed specifically for immersive capture, hybrid environments that combine real-world elements with digital extensions, etc.

In further reference to FIG. 1A, system 100 may receive video data from the plurality of capture nodes 115, such as capture nodes 115A, 115B, 115C, etc., where each capture node may include a unique identifier (UID). The plurality of capture nodes may include any suitable digital video camera (e.g., spatial camera, 360° camera, light field camera, stereo 3D camera, etc.) to capture images in the physical space and then convert (in real-time or near-real-time) the captured images into digital video data to be transmitted to a processing system (e.g., system 100). In such instances, the digital video data may include both standard video information (e.g., resolution, frame rate, exposure settings, etc.) as well as spatial information (e.g., camera position/orientation, motion tracking data etc.), etc. In modern immersive video workflows, the combination of standard video information and spatial video information may be characterized as a “video object” that consists of the video signal itself and its associated video metadata that defines its spatial properties. In addition, the plurality of capture nodes 115 may be configured in various arrangements or arrays to capture spatial video information related to the physical space (e.g., free-viewpoint video, volumetric capture, 180° or 360° video, etc.). In an aspect, the plurality of capture nodes may be arranged in a mixed reality volumetric video capture array with a 180° or 360° field of view. It should be noted that the position of each of the plurality of capture nodes 115 may change throughout the physical space and that system 100 may track the position of each of the plurality of capture nodes 115 in real-time.

In further reference to FIG. 1A, system 100 may receive audio data from a plurality of microphones 113, such as microphones 113A, 113B, 113C, etc., which may be configured in various different arrangements or arrays to capture spatial audio information related to the physical space (e.g., ambisonics arrays, binaural recording systems, object-based audio capture, etc.). The plurality of microphones may include any suitable microphone (e.g., spatial microphone, directional microphone, omnidirectional microphone, ambisonics microphone, binaural microphone, etc.) to capture sound sources in the physical space and then convert the captured sound sources into digital audio data to be transmitted to a processing system (e.g., system 100). In such instances, the digital audio data may include both standard audio information (e.g., frequencies, amplitudes, phase, signal-to-noise ratio, etc.) as well as spatial information (e.g., position, movement, direction, etc.). In modern immersive audio workflows, the combination of standard audio information and spatial audio information may be characterized as an “audio object” that consists of the audio signal itself as well as its associated audio metadata that defines its spatial properties, where each audio object may include a unique identifier (audio object UID). In the example of FIG. 1A, system 100 includes audio objects 123A, 123B, 123C, 123D. Further, the audio objects may be represented in accordance with any suitable content model (e.g., audio definition model (ADM), etc.) and structured/formatted into any suitable syntax (e.g., extensible markup language (XML), etc.). It should be noted that the position of each of the audio objects 123 may change throughout the physical space and that system 100 may track the position of each of the audio objects 123 in real-time.

Still referring to FIG. 1A, system 100 may process the video data to extract capture node locations for each of the plurality of capture nodes, and may process the audio data to extract audio object scene locations for each of the audio objects. For example, system 100 may process the raw video data received from the plurality of capture nodes 115 to extract video objects, which may include content metadata (e.g., object identification, object motion tracking, etc.) as well as capture node metadata. The capture node metadata may include spatial information such as camera position coordinates (e.g., x-y-z coordinates, etc.), camera orientation (e.g., pan, tilt, roll, etc.), field of view, focal length, depth information, motion tracking data, spatial relationships between cameras in multi-camera setups, etc., for each of the plurality of capture nodes 115. In an aspect, system 100 processes the video data received from the plurality of capture nodes to extract the capture node locations 117 for each of the plurality of capture nodes 115. For example, in FIG. 1A, capture node 115A includes capture node location 117A, capture node 115B includes capture node location 117B, and capture node 115C includes capture node location 117C. Similarly, system 100 may process the raw audio data received from the plurality of microphones 113 to extract audio objects 123 that include spatial information such as the 3D coordinates (e.g., x, y, z orientation), direction, distance, movement (e.g., velocity, trajectory, etc.), etc., for each sound source. In an aspect, system 100 processes the audio data received from the plurality of microphones 113 to extract audio objects 123 and audio object scene locations 133 for each sound source captured by the plurality of microphones 113, where the audio object scene locations 133 may be considered the 3D coordinates (e.g., x-y-z orientation, etc.) of each sound source in the physical space. For example, in FIG. 1A, audio object 123A includes audio object scene location 133A, audio object 123B includes audio object scene location 133B, audio object 123C include audio object scene location 133C, and audio object 123D include audio object scene location 133D. It should be noted that the spatial information related to the audio objects (e.g., audio object scene locations, etc.) and the video objects (e.g., capture node locations, etc.) may be measured by a physical coordinate system (e.g., x-y-z orientation, etc.) from a physical origin point in the physical space. For example, the center circle located at half court of a basketball court may be designated as the physical origin point in the physical space, where the x-axis may run parallel to the sideline, the y-axis may run parallel to the baseline, and the z-axis may represent a height or vertical dimension. In other aspects, the physical origin point may be viewer-centric, such as in virtual reality productions where the physical origin point represents the head position of the viewer.

Still referring to FIG. 1A, system 100 may map the capture node locations and the audio object scene locations to a virtual space (e.g., global volume, etc.) to establish a virtual “scene definition” or “scene description” of the physical space. The virtual space may act as a digital environment that provides a three-dimensional framework to define the spatial relationships between the audio objects and video objects. In this way, the scene definition stage creates a virtual space that can act as a “digital stage” upon which the immersive experience may be constructed. Similar to the physical space, the spatial relationships in the virtual space may be measured by a virtual coordinate system from a virtual origin point (e.g., global origin, etc.), where the virtual coordinate system corresponds to (and maintains) the spatial relationships of the physical coordinate system. For example, when translating the physical space to the virtual space, the physical distances in the physical space may be scaled to match the units in the virtual space. In such instances, 1 meter in the physical space may equal 10 units in the virtual space. Further, system 100 may perform an origin offset so that (0,0,0) of the physical origin point in the physical space corresponds to (0,0,0) of the virtual origin point in the virtual space. Further still, system 100 may perform an axis orientation adjustment so that the x-y-z axes of the physical space correspond to the x-y-z axes of the virtual space. As such, system 100 may include a shared worldscale, such as shared worldscale 122 in FIG. 1A, to perform the above operations as well as additional operations as needed to preserve the relative spatial relationships of the audio objects and video objects in the physical and virtual spaces.

System 100 may then determine audio object presentation locations 143 for each of the audio objects 123 in virtual space 120 based on a selected capture node. In immersive media productions, each capture node in the plurality of capture nodes represents a different perspective within the virtual space. Further, a production may switch between any of the plurality of capture nodes to select a new perspective that best serves the narrative of the moment. However, unlike traditional media productions that merely switch between different video feeds to select a new perspective, immersive media productions must also recompute all the spatial relationships from the new perspective. In such instances, rather than determining audio object scene locations for each audio object in relation to the virtual origin point, system 100 determines audio object presentation locations 143 for each audio object 123 in relation to the selected capture node, where the selected capture node acts as the new reference point (e.g., capture node origin point) from which the audio objects are measured. In this way, the metadata processing stage transforms the spatial information from a global reference frame to a camera-specific reference frame for presentation to the user. The reframing of the audio objects from the global reference frame measured against the global origin (e.g., virtual origin point) to the camera-specific reference frame measured against the camera-specific origin (e.g., capture node origin point) may be calculated in accordance with equation (1) directly below:

AO(x)PL_{CaptureNode(x)}=−1*([X_{CN(x)L}, Y_{CN(x)L}, Z_{CN(x)L}]−[X_{AO(x)SL}, Y_{AO(x)SL}, Z_{AO(x)SL}]) (1)

In equation (1) directly above, [X_{CN(x)L}, Y_{CN(x)L}, Z_{CN(x)L}] represents the capture node locations of the selected capture node, [X_{AO(x)SL}, Y_{AO(x)SL}, Z_{AO(x)SL}] represents the audio object scene locations of the audio objects, and AO(x)PL_{CaptureNode(x)} represents the resultant audio object presentation locations. Further, equation (1) may be computed either before or after selection of the selected capture node from which the audio objects may be measured. For example, in one aspect, system 100 may determine the audio object presentation locations for each of the audio objects in the virtual space after a specific capture node is selected as the new reference frame. In another aspect, system 100 may determine the audio object presentation locations for each of the audio objects in the virtual space with respect to all the capture nodes in the plurality of capture nodes before a specific capture node is selected as the new reference frame. In this way, the audio object presentation location determinations may occur “simultaneously” for each of the audio objects before selection of the selected capture node, rather than occurring only upon the selection of the selected capture node (and only with respect to the selected capture node).

System 100 may then generate spatial audio based on the audio objects and the audio object presentation locations determined for each of the audio objects as measured from the capture node origin point of the selected capture node. By generating spatial audio based on the audio objects and their respective audio object presentation locations measured from a selected capture node, system 100 can transform the audio objects into the actual audio signals that will be presented to the user on an immersive device. In this way, the soundfield processing stage acts as a bridge between the mathematical representations of the audio objects in the virtual space and the perceptual experience of the user in the immersive device. In some aspects, system 100 can create a presentation soundfield (e.g., spatial audio environment, etc.), such as presentation soundfield 160, based on the audio object presentation locations 143A, 143B, 143C, 143D determined for audio objects 123A, 123B, 123C, 123D, respectively, as measured from the capture node location of the selected capture node. In one aspect, presentation soundfield 160 may be a higher order audio (HOA) soundfield via standard vector based audio panning (VBAP).

In other aspects, generating spatial audio based on the audio objects and their respective audio object presentation locations measured from a selected capture node may require adjusting an azimuth parameter of the spatial audio to align with a visual perspective of the selected capture node. For example, many spatial audio formats use a coordinate system where “front” or “north” is along a particular axis (e.g., x-axis, y-axis, etc.), which may not align with the orientation of the selected capture node. As a result, the orientation of the presentation soundfield may need to be corrected or realigned in order to align with the orientation of the selected capture node. In this way, system 100 may account for any differences between the orientation of the selected capture node and the default orientation of the audio format. In such instances, an azimuth parameter (e.g., soundfield azimuth delta 163) may be calculated in accordance with equation (2) directly below:

SAD_{CN(x)L}=0+Azimuth_{CN(x)L} (2)

In equation (2) directly above, Azimuth_{CN(x)L} represents the rotational azimuth of the selected capture node, where SAD_{CN(x)L} represents the resultant soundfield azimuth delta to be applied to the soundfield. As such, the soundfield azimuth delta 163 (e.g., 163A, 163B, 163C, etc.) may vary based on the azimuth coordinates of each selected capture node (e.g., 115A, 115B, 115C, etc.), respectively.

Once the auditory perspective of the spatial audio aligns with the visual perspective of the selected capture node, the spatial audio and the video data of the selected capture node may be transmitted synchronously to an immersive device, such as immersive device 170 in FIG. 1A, where the spatial audio, video data and any associated metadata may be encoded prior to transmission. The immersive device may include a display system (e.g., micro-organic light-emitting diode (OLED) displays, etc.), tracking system (e.g., eye tracking, head position tracking, etc.), audio system (e.g., spatial audio speakers, microphones, etc.), power system (e.g., battery, connection cables/ports), etc., as well as processing circuitry and a memory that stores a set of instructions that when executed by the processing circuitry carry out the operations of immersive device 170. In some aspects, the immersive device 170 may include head-worn devices, which may include but are not limited to virtual reality (VR) headsets, augmented reality (AR) headsets/glasses, mixed reality (MR) systems, etc. In other aspects, immersive device 170 may include non-head-worn devices, such as room-scale production systems (e.g., cave automatic virtual environment (CAVE), etc.), dome theaters with spatial audio, home theater systems, mobile devices, etc.

Further, in some aspects, immersive device 170 can render the received spatial audio to create a complete spatial audio environment to be presented to the user. For example, immersive device 170 can determine the format of the spatial audio (e.g., binaural, first order ambisonics, higher order ambisonics, etc.), add environmental characteristics (e.g., room acoustics, distance attenuation, occlusion/obstruction effects, etc.), personalize the spatial audio (e.g., accessibility adaptations, etc.), adjust for real-time interactions (e.g., responding to viewer head or eye movements, etc.), decode the spatial audio based on the received metadata (e.g., decode the spatial audio codec into binaural format for playback, etc.), etc., or any combination thereof. In other aspects, the rendering of spatial audio may be performed by (or distributed across) multiple different devices for efficiency. For example, system 100 may transmit the spatial audio and video data to one or more intermediary devices (e.g., media receiver, decoder unit, etc.), where the one or more intermediary devices may perform intermediary processing operations (e.g., format conversion, final mix adjustments, etc.) before immersive device 170 may perform the final personalized processing operations (e.g., head-tracking adjustments, binaural processing, etc.). It should be noted that the above example is merely illustrative (not exhaustive) and that other combinations of operations performed on other devices are contemplated.

Referring now to FIG. 1B, a schematic illustration of processing device 180 in physical space 110 is shown in accordance with aspects. Physical space 110 may include a plurality of microphones 113, such as microphones 113A, 113B, 113C, as well as a plurality of capture nodes 115, such as capture nodes 115A, 115B, 115C, as illustrated in FIG. 1B. Further, the audio objects extracted from the audio data captured by microphones 113A, 113B, 113C and the video objects (including capture node locations) extracted from the video data captured by capture nodes 115A, 115B, 115C may be measured from physical origin point 111. The plurality of microphones 113 and the plurality of capture nodes 115 may be connected to processing device 180, where the connection may be wired (e.g., serial digital interface (SDI), external line return (XLR), universal serial bus (USB), etc.), wireless (e.g., WiFi-based transmission, radio frequency-based wireless systems, etc.) or any combination thereof. As illustrated in FIG. 1B, processing device 180 may include audio input 114 to receive the audio data from the plurality of microphones 113, video input 116 to receive the video data from the plurality of capture nodes 115, processing circuitry 182 (e.g., central processing units, graphics processing unit, specialized digital signal processing (DSP) chips, etc.) and memory 184 (e.g., random access memory, etc.) that stores a set of instructions 185 that when executed by the processing circuitry 182 carry out the operations of system 100. As illustrated in FIG. 1B, a singular processing device (e.g., processing device 180) may perform the operations of system 100 for the plurality of microphones 113 and the plurality of capture nodes 115, as opposed to conventional productions in which each individual capture node and each individual microphone would require its own respective processing device. In this way, system 100 offers a drastic reduction in the set-up time needed to create multiple spatial audio presentations per camera, as well as a reduction in audio routing complexity, audio channel count, processing resources, and network bandwidth required during live transmission. Further, as illustrated in the example of FIG. 1B, all the operations of system 100 (e.g., scene definition, metadata processing, soundfield processing, etc.) may be performed by processing device 180, where the spatial audio and video data may be transmitted to immersive device 170 for rendering and presentation to the user. In some aspects, the spatial audio and video data may be transmitted to one or more intermediary devices (not shown), such as a media receiver, before transmission to immersive device 170.

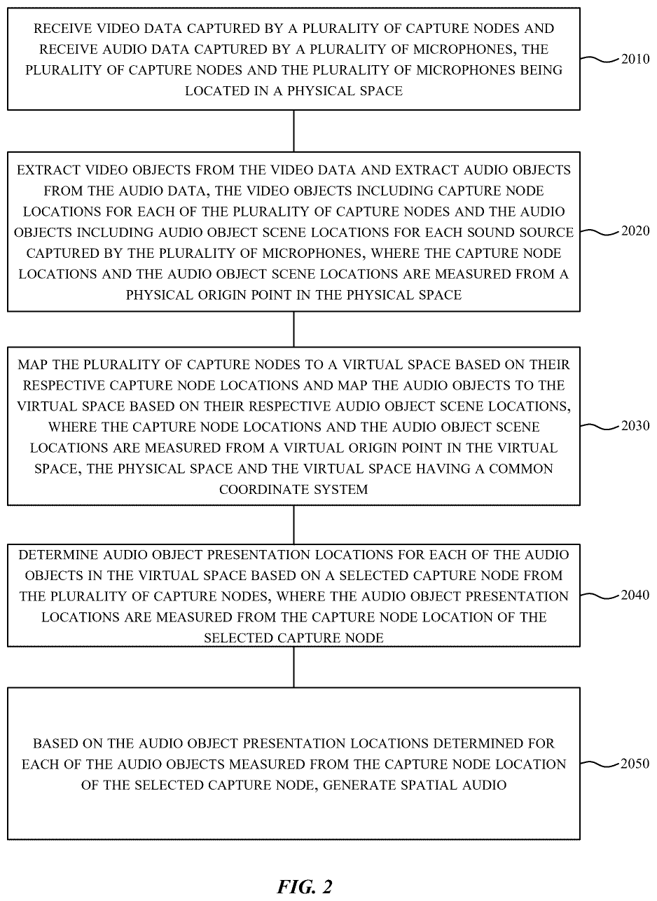

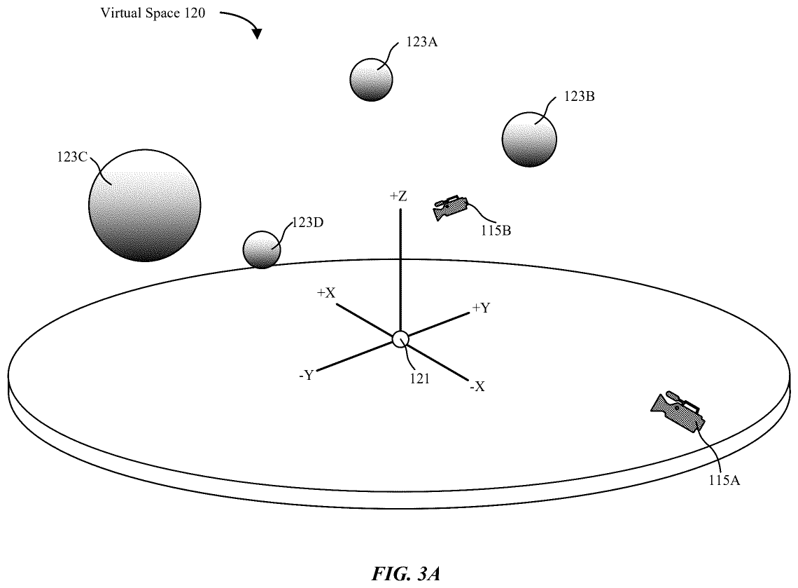

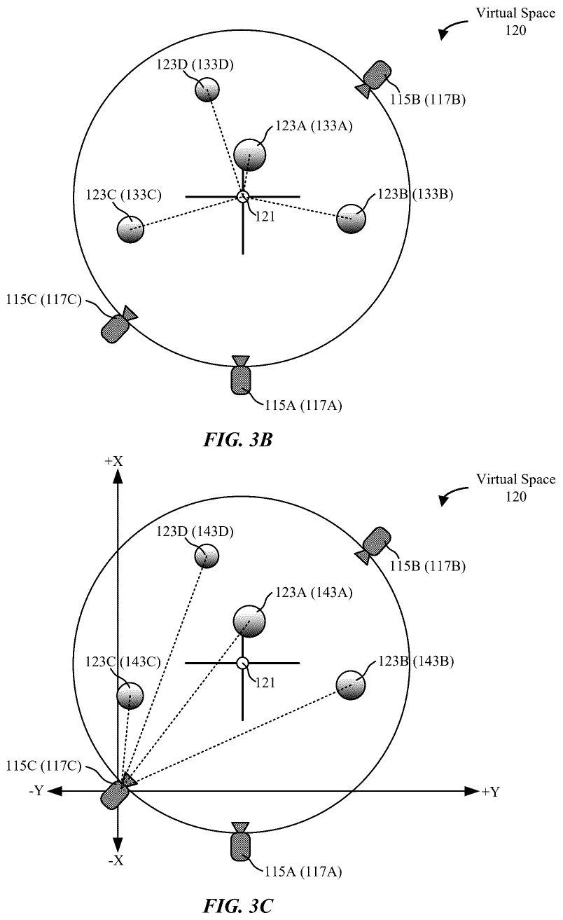

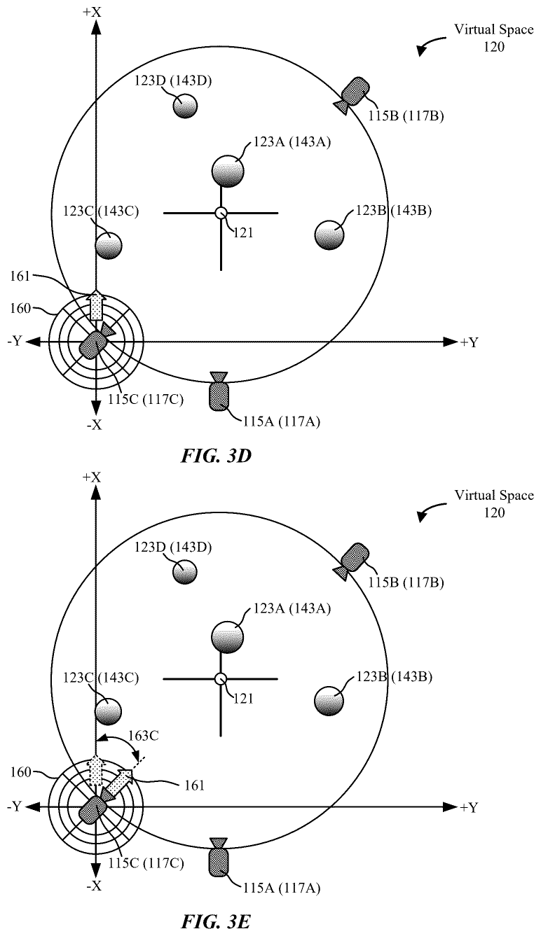

Referring now to FIG. 2 and FIGS. 3A-3E, FIG. 2 is a flow chart of a method for the respatialization of audio objects, FIG. 3A is a schematic perspective view illustration of a virtual space 120 from the perspective of selected capture node 115C, and FIGS. 3B-3E are schematic top view illustrations of a method for the respatialization of audio objects in the virtual space illustrated in FIG. 3A in accordance with aspects. In the interest of clarity and conciseness, the method of FIG. 2 is described concurrently with the illustrations of FIGS. 3A-3E. As shown in FIG. 3A, after receiving the video data captured by the plurality of capture nodes 115 and receiving the audio data captured by the plurality of microphones 113 located in physical space 110 (operation 2010), system 100 may extract audio objects 123 (and audio object scene locations 133) from the audio data and extract capture node locations 117 from the video data (operation 2020) and then map the audio objects 123 and the plurality of capture nodes 115 to virtual space 120 (operation 2030), as illustrated in FIG. 3A.

Referring now to FIG. 3B, virtual space 120 includes capture nodes 115A, 115B, 115C and audio objects 123A, 123B, 123C, 123D, where the capture node locations 117 for each capture node 115 and the audio object scene locations 133 for each audio object 123 may be measured from virtual origin point 121. It should be noted that the virtual space and the physical space have a common coordinate system (x-y-z coordinate system), so that the locations of the capture nodes and audio objects in the virtual space correspond to the locations of the capture nodes and sound sources in the physical space. In this way, the virtual space may maintain the spatial relationships of the physical space. In the example of FIG. 3B, the capture node location 117A for capture node 115A is (−1500, 0, 500, 0°), the capture node location 117B for capture node 115B is (935, 1000, 610, −129°), and the capture node location 117C for capture node 115C is (−760, −800, 490, 34°), where all such locations are measured from (0, 0, 0) at virtual origin point 121. Similarly, the audio object scene location 133A for audio object 123A is (250, 50, 1000), the audio object scene location 133B for audio object 123B is (−150, 750, 750), the audio object scene location 133C for audio object 123C is (−250, −850, 500), and the audio object scene location 133D for audio object 123D is (900, −300, 250), where all locations are measured from (0, 0, 0) at virtual origin point 121.

Referring now to FIG. 3C, capture node 115C may be selected as the capture node to be presented to the user, where the selecting of (or the switching between) capture nodes may be human-directed (e.g., director in a control room, etc.), automated (e.g., machine learning algorithms that analyze content in real-time, systems trained to recognize important moments or events, etc.) or any combination thereof. In such instances, rather than measure the locations of the audio objects from the virtual origin point as described at operation 2030, system 100 may measure the locations of the audio object from the capture node origin point of the selected capture node at operation 2040, where such measurements are the audio object presentation locations for each audio object. For example, in FIG. 3C, capture node 115C is the selected capture node, where the capture node location 117C for capture node 115C (−760, −800, 490, 34°) becomes the capture node origin point from which the audio objects may be measured. As such, in accordance with equation (1) above, the audio object presentation location 143A for audio object 123A is (1010, 850, 510), the audio object presentation location 143B for audio object 123B is (610, 1550, 260), the audio object presentation location 143C for audio object 123C is (510, −50, 10), and the audio object presentation location 143D for audio object 123D is (1660, 500, −240), where all locations are measured from the capture node origin point (e.g., capture node location 117C) of the selected capture node 115C.

Referring now to FIGS. 3D-3E, at operation 2050 system 100 may generate spatial audio based on the audio objects and the audio object presentation locations determined for each of the audio objects as measured from selected capture node 115C. In such instances, system 100 may create a presentation soundfield (e.g., spatial audio environment) based on the audio object presentation locations 143 determined at operation 2040. For example, in FIG. 3D, system 100 may create presentation soundfield 160 based on audio object presentation locations 143A, 143B, 143C, 143D for audio objects 123A, 123B, 123C, 123D, respectively. Further, the orientation of the presentation soundfield (e.g., presentation soundfield orientation 161) may need to be corrected or realigned in order to align with the orientation of the selected capture node. For example, many spatial audio formats use a coordinate system where “front” or “north” is along a particular axis (e.g., x-axis, y-axis, etc.), which may not align with the orientation of the selected capture node. For example, in FIG. 3D, the presentation soundfield orientation 161 of soundfield 160 aligns with the x-axis, but the orientation of the selected capture node 115C does not align with the x-axis. In order to correct or realign the presentation soundfield orientation to align with the orientation of the selected capture node, system 100 may determine an azimuth parameter (e.g., soundfield azimuth delta 163) that accounts for the difference. As such, in accordance with equation (2) above, system 100 may determine that soundfield azimuth delta 163C for capture node 115C is 34°, where the presentation soundfield 160 may be rotated by 34° so that its presentation soundfield orientation 161 aligns with the orientation of the selected capture node 115C, as illustrated in FIG. 3E. The resultant spatial audio may then be synchronized with the video data of selected capture node 115C and then transmitted to immersive device 170 (e.g., head-worn device, non-head-worn device, etc.) for rendering and presentation to the user.

In aspects, an extended reality (XR) environment refers to a wholly or partially simulated environment that people sense and/or interact with via an electronic system. In XR, a subset of a person's physical motions, or representations thereof, are tracked, and, in response, one or more characteristics of one or more virtual objects simulated in the XR environment are adjusted in a manner that comports with at least one law of physics. For example, an XR system may detect a person's head turning and, in response, adjust graphical content and an acoustic field presented to the person in a manner similar to how such views and sounds would change in a physical environment. In some situations (e.g., for accessibility reasons), adjustments to characteristic(s) of virtual object(s) in a XR environment may be made in response to representations of physical motions (e.g., vocal commands). A person may sense and/or interact with an XR object using any one of their senses, including sight, sound, touch, taste, and smell. For example, a person may sense and/or interact with audio objects that create 3D or spatial audio environment that provides the perception of point audio sources in 3D space. In another example, audio objects may enable audio transparency, which selectively incorporates ambient sounds from the physical environment with or without computer-generated audio. In some XR environments, a person may sense and/or interact only with audio objects.

Examples of XR include virtual reality and mixed reality. A virtual reality (VR) environment refers to a simulated environment that is designed to be based entirely on computer-generated sensory inputs for one or more senses. A VR environment comprises a plurality of virtual objects with which a person may sense and/or interact. For example, computer-generated imagery of trees, buildings, and avatars representing people are examples of virtual objects. A person may sense and/or interact with virtual objects in the VR environment through a simulation of the person's presence within the computer-generated environment, and/or through a simulation of a subset of the person's physical movements within the computer-generated environment. In contrast to a VR environment, which is designed to be based entirely on computer-generated sensory inputs, a mixed reality (MR) environment refers to a simulated environment that is designed to incorporate sensory inputs from the physical environment, or a representation thereof, in addition to including computer-generated sensory inputs (e.g., virtual objects). On a virtuality continuum, a mixed reality environment is anywhere between, but not including, a wholly physical environment at one end and virtual reality environment at the other end. In some MR environments, computer-generated sensory inputs may respond to changes in sensory inputs from the physical environment. Also, some electronic systems for presenting an MR environment may track location and/or orientation with respect to the physical environment to enable virtual objects to interact with real objects (that is, physical articles from the physical environment or representations thereof). For example, a system may account for movements so that a virtual tree appears stationery with respect to the physical ground.

One example of mixed reality includes augmented reality. An augmented reality (AR) environment refers to a simulated environment in which one or more virtual objects are superimposed over a physical environment, or a representation thereof. For example, an electronic system for presenting an AR environment may have a transparent or translucent display through which a person may directly view the physical environment. The system may be configured to present virtual objects on the transparent or translucent display, so that a person, using the system, perceives the virtual objects superimposed over the physical environment. Alternatively, a system may have an opaque display and one or more imaging sensors that capture images or video of the physical environment, which are representations of the physical environment. The system composites the images or video with virtual objects, and presents the composition on the opaque display. A person, using the system, indirectly views the physical environment by way of the images or video of the physical environment, and perceives the virtual objects superimposed over the physical environment. As used herein, a video of the physical environment shown on an opaque display is called “pass-through video,” meaning a system uses one or more image sensor(s) to capture images of the physical environment, and uses those images in presenting the AR environment on the opaque display. Further alternatively, a system may have a projection system that projects virtual objects into the physical environment, for example, as a hologram or on a physical surface, so that a person, using the system, perceives the virtual objects superimposed over the physical environment. An augmented reality environment also refers to a simulated environment in which a representation of a physical environment is transformed by computer-generated sensory information. For example, in providing pass-through video, a system may transform one or more sensor images to impose a select perspective (e.g., viewpoint) different than the perspective captured by the imaging sensors. As another example, a representation of a physical environment may be transformed by graphically modifying (e.g., enlarging) portions thereof, such that the modified portion may be representative but not photorealistic versions of the originally captured images. As a further example, a representation of a physical environment may be transformed by graphically eliminating or obfuscating portions thereof.

Another example of mixed reality includes augmented virtuality. An augmented virtuality (AV) environment refers to a simulated environment in which a virtual or computer generated environment incorporates one or more sensory inputs from the physical environment. The sensory inputs may be representations of one or more characteristics of the physical environment. For example, an AV park may have virtual trees and virtual buildings, but people with faces photorealistically reproduced from images taken of physical people. As another example, a virtual object may adopt a shape or color of a physical article imaged by one or more imaging sensors. As a further example, a virtual object may adopt shadows consistent with the position of the sun in the physical environment.

Further, there are many different types of electronic systems that enable a person to sense and/or interact with various XR environments. Examples include head mounted systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head mounted system may have one or more speaker(s) and an integrated opaque display. Alternatively, a head mounted system may be configured to accept an external opaque display (e.g., a smartphone). The head mounted system may incorporate one or more imaging sensors to capture images or video of the physical environment, and/or one or more microphones to capture audio of the physical environment. Rather than an opaque display, a head mounted system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In one aspect, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface.

In utilizing the various aspects of the aspects, it would become apparent to one skilled in the art that combinations or variations of the above aspects are possible for the respatialization of audio objects. Although the aspects have been described in language specific to structural features and/or methodological acts, it is to be understood that the appended claims are not necessarily limited to the specific features or acts described. The specific features and acts disclosed are instead to be understood as aspects of the claims useful for illustration.

What is claimed is:

1. A method for respatialization of audio objects comprising:
receiving video data captured by a plurality of capture nodes and receiving audio data captured by a plurality of microphones, the plurality of capture nodes and the plurality of microphones being located in a physical space;
extracting video objects from the video data and extracting audio objects from the audio data, the video objects including capture node locations for each of the plurality of capture nodes and the audio objects including audio object scene locations for each sound source captured by the plurality of microphones, wherein the capture node locations and the audio object scene locations are measured from a physical origin point in the physical space;
mapping the plurality of capture nodes to a virtual space based on their respective capture node locations and mapping the audio objects to the virtual space based on their respective audio object scene locations, wherein the capture node locations and the audio object scene locations are measured from a virtual origin point in the virtual space, the physical space and the virtual space having a common coordinate system;
determining audio object presentation locations for each of the audio objects in the virtual space based on a selected capture node from the plurality of capture nodes, wherein the audio object presentation locations are measured from the capture node location of the selected capture node; and
based on the audio objects and the audio object presentation locations determined for each of the audio objects measured from the capture node location of the selected capture node, generating spatial audio.

2. The method of claim 1, wherein the plurality of capture nodes includes digital video cameras located in the physical space.

3. The method of claim 1, wherein the plurality of capture nodes each includes a unique identifier to identify the selected capture node from the plurality of capture nodes.

4. The method of claim 1, wherein determining audio object presentation locations for each of the audio objects in the virtual space occurs simultaneously for all of the plurality of capture nodes before selection of the selected capture node.

5. The method of claim 1, wherein generating the spatial audio includes creating a presentation soundfield, the presentation soundfield including a higher order audio (HOA) soundfield.

6. The method of claim 1, wherein generating the spatial audio includes determining an azimuth parameter to align an auditory perspective of the spatial audio to a visual perspective of the video data of the selected capture node.

7. The method of claim 1, further comprising synchronizing the spatial audio with the video data of the selected capture node and transmitting the synchronized spatial audio and video data to an immersive device, the immersive device being a head-worn device.

8. A processing device comprising:
an audio input;
a video input;
a memory to store a set of instructions; and
processing circuitry to execute the set of instructions to:
receive, through the video input, video data captured by a plurality of capture nodes and receive, through the audio input, audio data captured by a plurality of microphones, the plurality of capture nodes and the plurality of microphones being located in a physical space;
extract video objects from the video data and extract audio objects from the audio data, the video objects including capture node locations for each of the plurality of capture nodes and the audio objects including audio object scene locations for each sound source captured by the plurality of microphones, wherein the capture node locations and the audio object scene locations are measured from a physical origin point in the physical space;
map the plurality of capture nodes to a virtual space based on their respective capture node locations and map the audio objects to the virtual space based on their respective audio object scene locations, wherein the capture node locations and the audio object scene locations are measured from a virtual origin point in the virtual space, the physical space and the virtual space having a common coordinate system;
determine audio object presentation locations for each of the audio objects in the virtual space based on a selected capture node from the plurality of capture nodes, wherein the audio object presentation locations are measured from the capture node location of the selected capture node; and
based on the audio objects and the audio object presentation locations determined for each of the audio objects measured from the capture node location of the selected capture node, generate spatial audio.

9. The processing device of claim 8, wherein the plurality of capture nodes includes digital video cameras located in the physical space.

10. The processing device of claim 8, wherein the plurality of capture nodes each includes a unique identifier to identify the selected capture node from the plurality of capture nodes.

11. The processing device of claim 8, wherein the processing circuitry executes the set of instructions to determine audio object presentation locations for each of the audio objects in the virtual space simultaneously for all of the plurality of capture nodes before selection of the selected capture node.

12. The processing device of claim 8, wherein the processing circuitry executes the set of instructions to generate the spatial audio by creating a presentation soundfield, the presentation soundfield including a higher order audio (HOA) soundfield.

13. The processing device of claim 8, wherein the processing circuitry executes the set of instructions to generate the spatial audio by determining an azimuth parameter to align an auditory perspective of the spatial audio to a visual perspective of the video data of the selected capture node.

14. The processing device of claim 8, wherein the processing circuitry executes the set of instructions to synchronize the spatial audio with the video data of the selected capture node and transmit the synchronized spatial audio and video data to an immersive device, the immersive device being a head-worn device.

15. An immersive device comprising:
a display system;
an audio system;
a memory to store a set of instructions; and
processing circuitry to execute the set of instructions to:
receive spatial audio and receive video data;
render the spatial audio and render the video data; and
present the spatial audio through the audio system and present the video data through the display system, the spatial audio and video data being synchronized.

16. The immersive device of claim 15, wherein the spatial audio includes audio objects and audio object presentation locations determined for each of the audio objects, the audio object presentation locations being measured from a capture node location of a selected capture node in a virtual space.

17. The immersive device of claim 16, wherein the audio object presentation locations are determined based on audio object scene locations for each sound source captured by a plurality of microphones, the audio object scene locations being measured from a virtual origin point in the virtual space.

18. The immersive device of claim 17, wherein the audio object scene locations and capture node locations are measured from a physical origin point in a physical space.

19. The immersive device of claim 16, wherein the virtual space corresponds to a physical space, the physical space and the virtual space having a common coordinate system.

20. The immersive device of claim 15, wherein the immersive device is a head-worn device.
